(19) United States
(12) Patent Application Publication
(10) Pub. No.: US 2006/0247562 A1
(43) Pub. Date: Nov. 2, 2006

(54) Passive resistance musculo-skeletal manipulation devices

(76) Inventor: Gregg Emmel, Venice, CA (US)

Correspondence Address: GREGG EMMEL, 1120 PRINCETON DR., VENICE, CA, 90292, US

(21) Appl. No.: 11/115,927

(22) Filed: Apr. 27, 2005

(51) Int. Cl. A61H 7/00

(52) U.S. Cl. 601/135

(57) ABSTRACT

Passive resistance musculo-skeletal manipulation massage devices with a set of three portable devices, each capable of being hand held and each specifically designed to allow users to effectively manipulate specific areas of the musculo-skeletal system. The portable devices are made of rigid or semi rigid material. The first portable device is oblong in shape and has a pair of protrusions directed upward and spaced to allow room for a person's larger muscles. The second portable device being wedge shaped. The third portable device having an approximately circular plan view shape and including a single centrally disposed raised protrusion. The portable devices are placed between a flat surface and the user's back and neck area. A preferred embodiment includes that the the first portable device has a radiused under portion to allow the user to rock on the device.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of portable massage devices and more specifically passive resistance musculo-skeletal manipulation devices. In recent years, the problem of back pain has become chronic in the United States. A recent Newsweek Magazine report has stated that over sixty-five million Americans share this painful affliction. The article goes on to state that back pain has become the number two reason for adult visits to a doctor; second only to coughs and colds. Although some types of back pain are so severe that only surgery may be an option, it has also been shown that various types of back massage combined with muscle strengthening exercises can be very effective in easing or eliminating back pain. To this end, a number of portable massage devices have been invented and marketed so that a person can perform a back massage on his or herself. for example, Christian. Howard, in his 2001 U.S. Pat. No. 6,315,742 discloses a device in which a plurality of ball shapes are mounted to a board so that the user can place the balls under his or her back and roll forward and backward on the balls to massage the spine and back. Similarly, Amos Stauft, in his 1983 U.S. Pat. No. 4,374,519, discloses a spinal massage device comprising four rubber balls mounted to a linking plate. This device is used in a similar way to the Howard device. The user's back is meant to lie on the balls and move forward and backward to allow the balls to travel up and down the user's spinal cord area. While these devices do aid in the ease of muscle tension in the back area, they have a number of deficiencies which the present invention remedies. The main deficiency is that the prior devices are generally simple ball or other radial shapes and do not incorporate profiles of complex curvature as a key element for massaging various muscle groups. Some muscle groups require a single domed shape where as others require a spaced pair of dome shapes, while others respond more favorably to a modified wedge shape. Additionally, my experiments have shown that it is more efficacious for a person to physically lie on or slide on a stationary contoured shape rather than for the massage device to move or roll. Finally, the prior art does not allow the user to easily operate the devices by holding in one's hand.

### BRIEF SUMMARY OF THE INVENTION

The primary object of the invention is to provide a set of portable stationary devices that allow users to effectively manipulate specific areas of the musculo-skeletal system. By introducing a form factor of complex curvature, the devices allow users to vary both the amount of resistance and the primary vector of resistance in real time.

Another object of the invention is to provide portable devices that aid in muscular regeneration.

Another object of the invention is to provide portable devices that improve skeletal alignment and balance.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed passive resistance musculo-skeletal manipulation devices comprising: a set of three portable devices, each capable of being hand held and each specifically designed with complex curved profiles to provide user-controllable manipulation of the musculo-skeletal system for spinal alignment and muscular regeneration, said portable devices made of rigid or semi rigid material such as wood, plastic resin, stone or high durometer rubber, said first portable device being approximately oblong in shape and having a pair of protrusions directed upward and spaced to allow room for a person's spinal column or other large muscles or joints to be suspended between said protrusions, said second portable device being wedge shaped with a plurality of rips and contours that create a device with multiple pressure points, and said third portable device having an approximately circular plan view shape and including a single centrally disposed raised protrusion, and said portable devices to be placed between a flat surface such as a floor or bed and the user's bodily area of application.

### BRIEF DESCRIPTION OF THE DRAWINGS

FIG. 1 is a perspective view of a double dome version of the invention.

FIG. 2 is a top view of the double dome version of the invention.

FIG. 3 is a side section view of the double dome version of the invention.

FIG. 4 is a side view of the double dome version of the invention.

FIG. 5 is a view of a person holding a single dome version of the invention.

FIG. 6 is a side view of the single dome version of the invention.

FIG. 7 is a top view of the single dome version of the invention.

FIG. 8 is a side section view of the single dome version of the invention.

FIG. 9 is a perspective view of a person using the single dome version of the invention.

FIG. 10 is a perspective view of a wedge shaped version of the invention.

FIG. 11 is a top view of the wedge shaped version of the invention.

FIG. 12 is a side section view of the wedge shaped version of the invention.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### DETAILED DESCRIPTION OF THE PREFERRED EMBODIMENTS

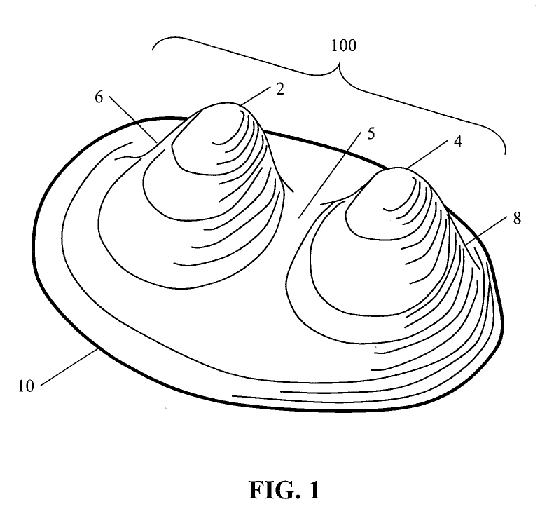

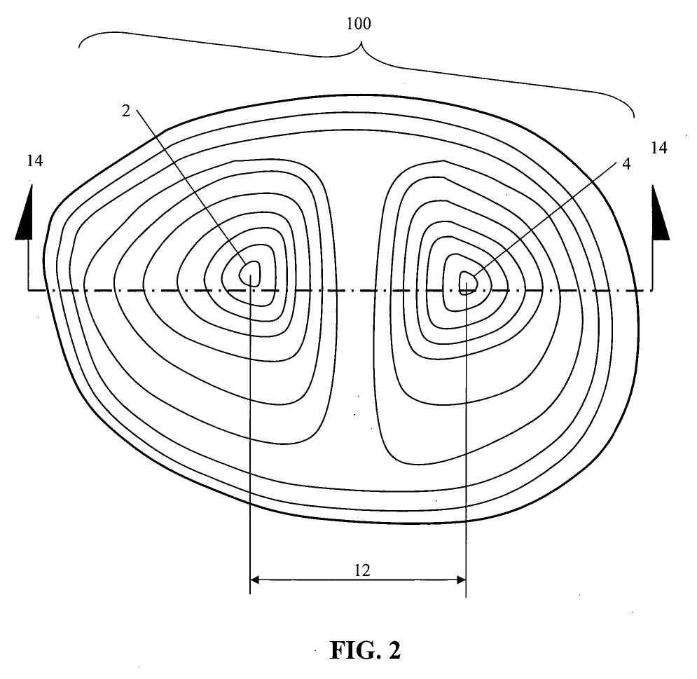

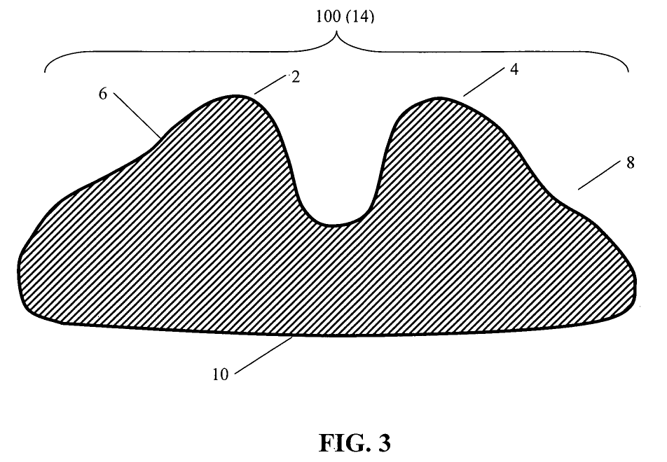

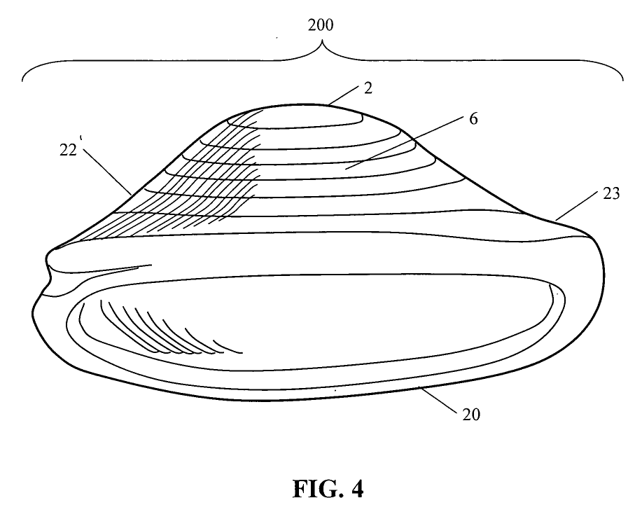

Referring now to FIG. 1 we see a perspective view of a double domed version of the present invention 100. The device 100 is roughly oblong in shape. The massage device is constructed of rigid or semi rigid material such as wood, resin, metal, stone or hard rubber. The domed areas 2, 4 are spaced so that the human spine or other large muscle or joint can be suspended in the space 5 between the domes 2, 4. The contour of the overall shape is complex in that the curvature on the left side 6 is more rounded than the curvature on the right side 8. This allows the user to choose exactly the degree of curvature for a particular spot on the body. To use the device, the user can place the device 100 on a flat surface such as a floor or bed and then lie on the device 100. The user can remain stationary or he can slide forward and backward to allow different parts of the body to be in contact with the device 100. Alternately, the user can hold the device 100 in his or her hand and forcefully massage his or her arms or legs or torso. FIG. 2 is a top view of the device 100. topological lines have been drawn to depict the complex rise and fall of each domed area 2, 4. The distance between dome tops 2, 4 is indicated by dimension line 12 and is approximately two and one half inches, which is ideal for suspending the human spine. Section line 14 is shown and the resulting side section can be seen in FIG. 3. Note that the bottom of the left side of the device 100 is curved up slightly. The difference in contour from left to right can be seen as shown by sloping lines 6, 8. FIG. 4 shows a side view of the device 100. radiused under section 20 allows the user to rock his or her back or other body part on the device and also allows the user slide his or her body up and down the device 100. One can also clearly see the further complex curvature of the device where the forward surface 22 rises at a lower angle than the rear surface 23, thereby giving even more choices for the user to select a portion of the device that best relates to a particular body part.

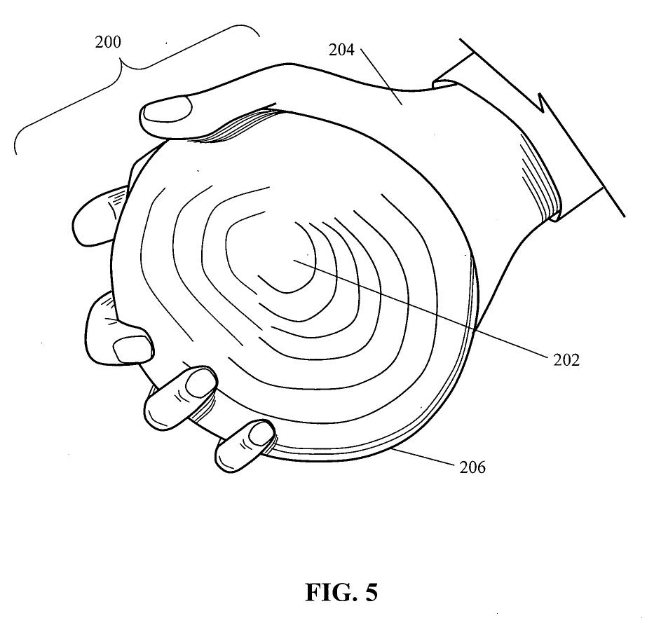

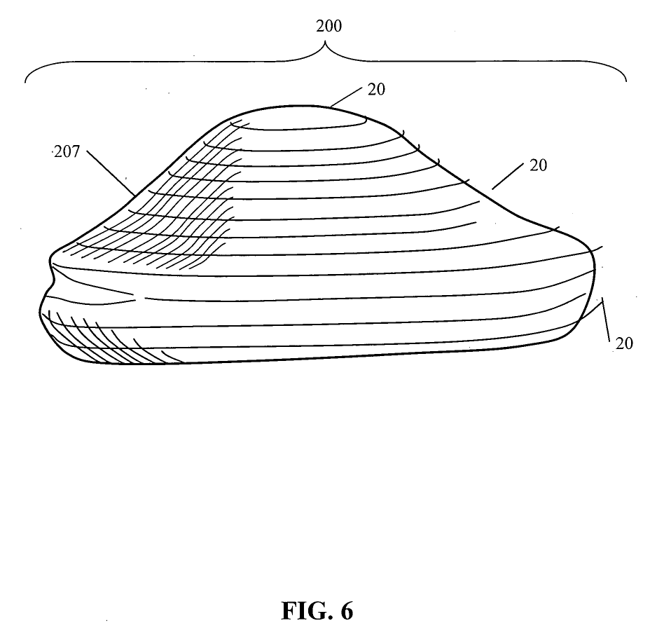

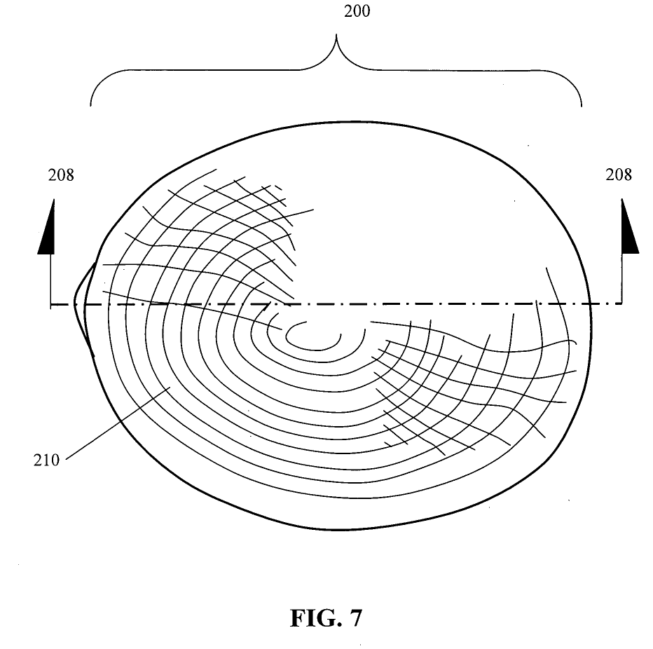

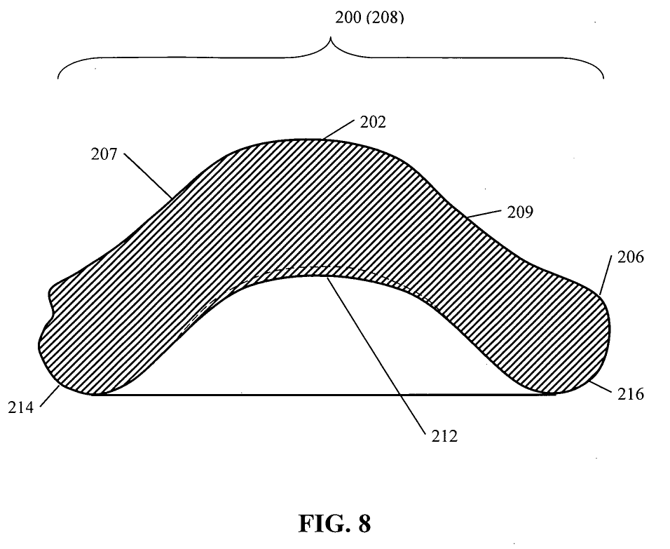

FIG. 5 shows a second, single domed version of the present invention 200. The diameter of the device 200 is such that the perimeter 206 of the device fits comfortably in a person's hand 204. FIG. 6 shows a side view of the device 200. Notice that even in this seemingly symmetrical design, there is a slight difference in the curvature of the left side 207 and the right side 209. This can be seen more clearly in FIG. 8. Referring now to FIG. 7 we see a top view of the single domed device 200. topological lines 210 show that the slope of dome 202 is gradual. Section line 208 bisects the device. Section view 208 can be seen in FIG. 8. Notice that the underside of the device 200 is concave 212 thereby producing an additional rounded edge 214. 216 to help massage muscular-skeletal groups that would benefit from this cup shaped design.

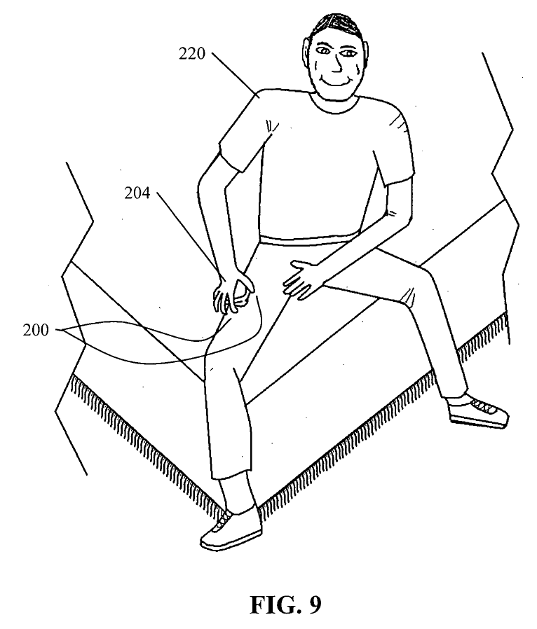

FIG. 9 shows a perspective view of a person 220 whose hand 204 is holding the single domed device 200. The single dome can press into large muscle groups such as those found in the thigh. Alternately, the user 220 can flip the device 200 upside down so that the rounded edges 214, 216 can make contact with the thigh.

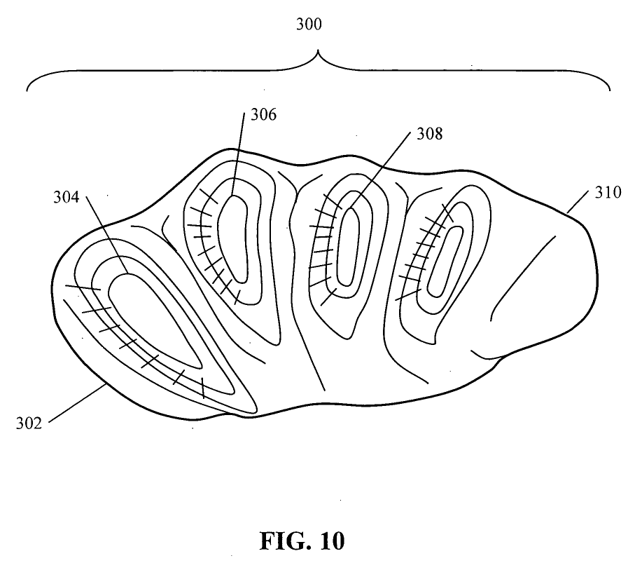

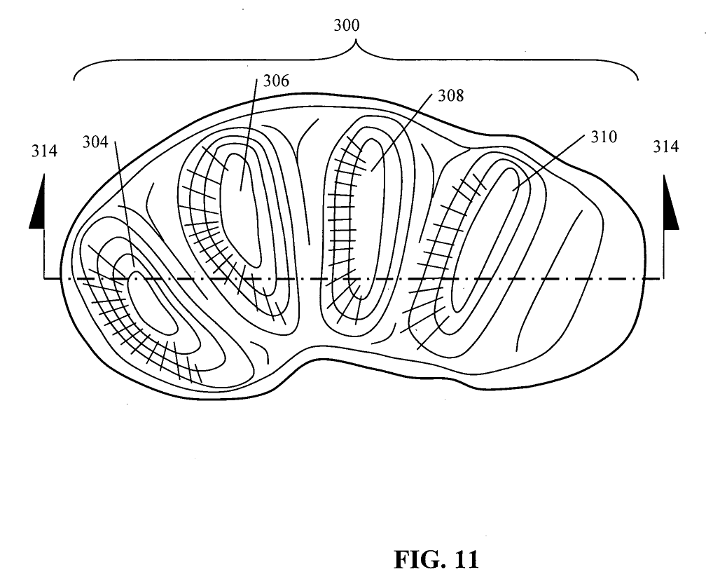

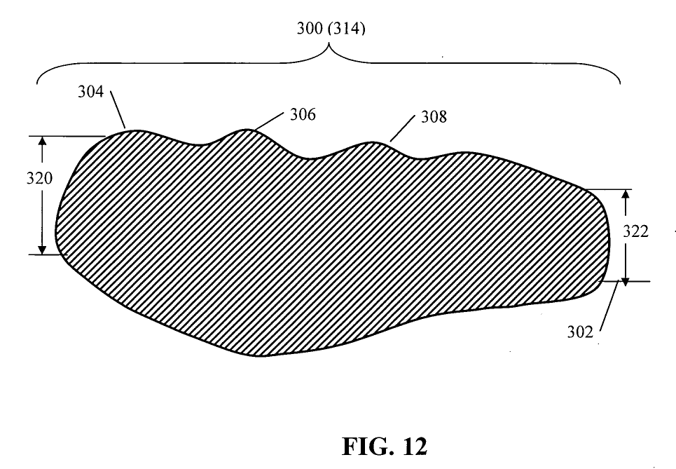

FIG. 10 shows a perspective view of a wedge shaped massage device 300. This device is thinner at one end 302 and thicker at the opposite end 310. End 302 is rounded so that the user can hold the fatter end 310 and press the smaller rounded end 302 into muscle groups for breaking up stress crystals that can form in the muscles and surrounding tissues. The wedge shape can also be placed between the user's back and a flat surface such as a floor or bed. My experience has shown that the various ribs and valleys of the wedge can stimulate circulation and reduce muscle tension in targeted spots on the body. The rises 304, 306, 308, 310 and intervening falls as shown in FIGS. 10 and 11 and in section view 12 provide a wide variety of contact points to interface with an equally wide variety of body parts. FIG. 12 shows section view 314 and clearly illustrates the overall wedge shape as defined by the left side dimension line 320 and the right side dimension line 322.

As a general note, any of the above devices can consist of a hollow construction thereby allowing for the inclusion of other materials such as gel, and for the inclusion of other items such as lights, audio devices, bio-feedback devices or micro-processors. Furthermore, an electrical jack can be added to the design to allow the user to plug in outside devices that can control, or give feedback from, the passive resistance musculo-skeletal manipulation devices described above.

It should be noted that the messaging devices shown and described above are also designed to be sculptural and aesthetically pleasing to the eye as well as to be very tactually satisfying when held by the hand of the user.

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Passive resistance musculo-skeletal manipulation devices comprising:
a set of three portable devices, each capable of being hand held and each specifically designed to allow users to effectively manipulate specific areas of the musculo-skeletal system;
said portable devices made of rigid or semi rigid material such as wood, plastic resin, stone or high durometer rubber;
said first portable device being approximately oblong in shape and having a pair of protrusions directed upward and spaced to allow room for a person's spinal column or large muscle groups or joints to be suspended between said protrusions;
said second portable device being roughly wedge shaped with a plurality of ribs and contours that create a device with multiple pressure points;
said third portable device having an approximately circular plan view shape and including a single centrally disposed raised protrusion; and
said portable devices to be placed between a flat surface such as a floor or bed and the user's musculo-skeletal area of application.

2. Passive resistance musculo-skeletal manipulation devices as claimed in claim 1 wherein said said first portable device includes a radiused under portion to allow the user to rock his or her body part on said device.

3. Passive resistance musculo-skeletal manipulation devices as claimed in claim 1 wherein said first portable device includes a ventral profile of complex curvature as a key, integral functional element, allowing users to vary both the amount of resistance and the primary vector of resistance in real-time and allowing said device to move along the spinal column.

4. Passive resistance musculo-skeletal manipulation massage devices as claimed in claim 1 wherein said first portable device can be made in several sizes, so that the distance between said upward protrusions is proportionally determined as a ratio of the gross scale of the device and where one said upward protrusion terminates in a radiused or curved portion proportionally determined as a ratio of the gross scale of the device and said second protrusion terminates in a radiused or curved portion proportionally determined as a ratio of the gross scale of the device.

5. Passive resistance musculo-skeletal manipulation devices as claimed in claim 1 wherein said third portable device includes a rounded perimeter portion proportionally determined as a ratio of the gross scale of the device and said central protrusion termination in a radiused portion proportionally determined as a ratio of the gross scale of the device.

6. Passive resistance musculo-skeletal manipulation massage devices as claimed in claim 1 wherein said second device has rounded corners and includes a plurality of ridges producing high spots and low spots for increased massaging effect.

7. Passive resistance musculo-skeletal manipulation massage devices as claimed in claim 1 wherein an alternate embodiment can include hollowed portions that can accept gel or other material that can be heated or cooled to further increase the healing effect of said devices.

8. Passive resistance musculo-skeletal manipulation massage devices as claimed in claim 1 wherein an alternate embodiment can include the addition of scented material.]

9. Passive resistance musculo-skeletal manipulation massage devices as claimed in claim 1 wherein an alternated embodiment can include the addition of lighting elements such as LED's and a power supply such as a battery to be housed within said devices.

10. Passive resistance musculb-skeletal manipulation massage devices as claimed in claim 1 wherein an alternate embodiment can include a vibratory element such as a DC motor equipped with an off center weight attached to its shaft and powered by one or more batteries.

11. Passive resistance musculo-skeletal manipulation massage device as claimed in claim 1 wherein an alternate embodiment can include a sound generating means such as an oscillator, an amplifier, a speaker and a power supply such as a battery.

12. Passive resistance musculo-skeletal manipulation massage device as claimed in claim 1 wherein an alternate embodiment can include installing a micro-processor within the said device that can provide bio-feedback or other information to the user and where an input or output jack can connect the said device to an auxiliary electronic unit.

13. Passive resistance musculo-skeletal manipulation massage device as claimed in claim 1 wherein an alternate embodiment can include a micro-processor to control said light or sound or vibration.

14. Passive resistance musculo-skeletal manipulation massage devices as claimed in claim 1 wherein an alternate embodiment can include any combination of any of the features described in the above claims.
